(19) United States
(12) Patent Application Publication
(10) Pub. No.: US 2026/0251208 A1
(43) Pub. Date: Aug. 27, 2026

(54) DRIVE GEAR AND LEAD SCREW CONFIGURATION WITH INTEGRATED SPEED SUMMING DIFFERENTIAL GEARING

(71) Applicant: Woodward, Inc., Fort Collins, CO (US)

(72) Inventor: Mariusz K. Kuczaj, Fort Collins, CO (US)

(21) Appl. No.: 19/063,505

(22) Filed: Feb. 26, 2025

(51) Int. Cl. F16H 48/10; F16H 48/38

(52) U.S. Cl. CPC F16H 48/10; F16H 48/38; F16H 2048/104

(57) ABSTRACT

Methods and systems include a differential gear assembly configured for speed summing of multiple gears. The assembly includes a first interface; a second interface; a splined lead screw shaft; a first set of planetary gears configured to be driven by the first interface; and a second set of planetary gears configured to be driven by the second interface. A cage is included to house the first and second set of planetary gears. In some examples, the splined lead screw shaft extends through a portion of the cage and is configured to rotate in conjunction with the cage in response to the first or second ring gear driving the first or second set of planetary gears. In some examples, the splined lead screw shaft translates through the cage in response to the first or second ring gear driving the first or second set of planetary gears and the shaft.

### PRIORITY CLAIM/INCORPORATION BY REFERENCE

N/A

### FIELD

Certain embodiments of the disclosure relate to a differential gear assembly configured for speed summing of multiple gears. More specifically, certain embodiments of the disclosure relate to a differential gear assembly that includes a multiple ring gears to receive mechanical power from an input, transferred to a screw gear via a plurality of planet gears. Advantageously, these differential assemblies and interfaces rotate about a single common axis.

### BACKGROUND

Existing multi-branch gear designs, which do not rotate about a common central axis, employ sun gears and are costly, heavy, and take valuable space in systems in which they are deployed.

Further limitations and disadvantages of conventional and traditional approaches will become apparent to one of skill in the art, through comparison of such systems with the present disclosure as set forth in the remainder of the present application with reference to the drawings.

### BRIEF SUMMARY

A system and/or method is provided for a differential gear assembly configured for speed summing of multiple gears. The assembly includes one or more of a first interface; a second interface; a splined lead screw shaft; a first set of planetary gears configured to be driven by the first interface; and a second set of planetary gears configured to be driven by the second interface. A cage is included to house the first and second set of planetary gears. In some examples, the splined lead screw shaft extends through a portion of the cage and includes a spline used to provide a rigid interface between the lead screw and the cage. The splined lead screw shaft is configured to rotate the cage in response to the first or second ring gear driving the first or second set of planetary gears, which in turn drive the splined lead screw shaft.

In view of the unique arrangement of components, the drive gear differential assembly is configured as a speed summing architecture, such that the differential can be driven by two separate motors directly or through speed reduction gearing.

These and various other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIGS. 1A to 1C illustrate multiple views of an example drive gear assembly with integrated speed summing differential gearing, in accordance with an example embodiment of the disclosure.

FIG. 2 illustrates another example drive gear assembly with integrated speed summing differential gearing, in accordance with an example embodiment of the disclosure.

FIGS. 3A to 3C illustrate multiple diagrammatic views of several example drive gear assembly with integrated speed summing differential gearing, in accordance with an example embodiment of the disclosure.

FIGS. 4A and 4B illustrate perspective views of example differential gearing with multiple sets of planetary gears, in accordance with an example embodiment of the disclosure, in accordance with an example embodiment of the disclosure.

FIG. 5 illustrates a diagrammatic view of a differential gear assembly arranged to receive power from multiple mechanical power sources, in accordance with an example embodiment of the disclosure.

The figures are not necessarily to scale. Where appropriate, similar or identical reference numbers are used to refer to similar or identical components.

### DETAILED DESCRIPTION

Disclosed examples are provided of a differential gear assembly configured for speed summing of multiple input gears. The assembly includes one or more of a first interface; a second interface; a splined lead screw shaft; a first set of planetary gears configured to be driven by the first interface; and a second set of planetary gears configured to be driven by the second interface. A cage is included to house the first and second set of planetary gears. In some examples, the splined lead screw shaft interfaces with the cage assembly to provide a rigid interface between the cage and the lead screw. In some configurations the spline may be replaced by a different shaped feature to provide the same functionality.

Conventional systems that employ linear electro-mechanical actuators (EMA) with multiple motors can be configured as speed summing or torque summing. Torque summing or a torque summing gear system, for example, is a configuration of gears that combines outputs of multiple gears into a single output. Thus, the output torque is the total output from all torques from each input gear. Speed summing, for example, is a specialized gear system designed to combine rotational speeds of two or more input gears into a single output. As a result of adding the speeds of the multiple inputs, a faster overall output is generated.

Disclosed examples describe improvements on the speed summing architecture of such actuators, which often employ differential gearing, regardless of whether the motors operate in an active-active mode or active-standby mode.

Existing EMA architecture uses standalone differential gearing that limits the options on how the motors are arranged within an EMA assembly. Some example arrangements place the various motors side-by-side, with their output shafts going directly into the differential. This arrangement provides a common output pinion for additional speed reduction gearing to a drive gear. However, this setup somewhat limits the EMA designer's freedom to place the motors on opposite sides of the EMA, which could create a flatter, lower profile EMA assembly envelope.

Some example linear EMAs use multiple speed summed motors (e.g., two or three speed-summed motors).

Another disadvantage of existing approaches is that standalone differential gearing requires a corresponding housing, which then suffers from a weight penalty. Thus, as the differential gearing still needs to be integrated into the housing, a housing redundancy is created that is neither required nor desirable, which inevitably requires additional hardware.

The disclosed drive gear assembly solves these problems by integrating a speed summing differential gearing into a drive gear that is normally attached to a leadscrew. This arrangement, which incorporates differential gearing into the drive gear, results in a very compact package and does not take any more space than a typical drive gear would.

As utilized herein, “and/or” means any one or more of the items in the list joined by “and/or”. For example, “x and/or y” means any element of the three-element set {(x), (y), (x, y)}. Similarly, “x, y, and/or z” means any element of the seven-element set {(x), (y), (z), (x, y), (x, z), (y, z), (x, y, z)}. As utilized herein, the term “module” refers to functions that can be implemented in hardware, software, firmware, or any combination of one or more thereof. As utilized herein, the term “exemplary” means serving as a non-limiting example, instance, or illustration.

Speed summing differential gearing incorporated upstream in a drive train may be able to accommodate additional gearing ratio downstream, thereby enabling an EMA to produce high output loads since torque transmitted through the differential can be relatively low. This distributed arrangement can be designed with a smaller differential as well. The downside of this approach is that a smaller differential may not be able to accommodate multiple sets of planetary gears. For instance, the size of a speed summing differential incorporated into the drive gear assembly is correlated to the size of the drive gear and the lead screw. To increase output torque, a greater number of planetary gear sets (e.g., more than three sets of planetary gears) may be used to create high capacity differential gearing. The resulting device has a large envelope and increased weight, which makes the entire packaging ineffective or impractical for a variety of applications (e.g., aerospace).

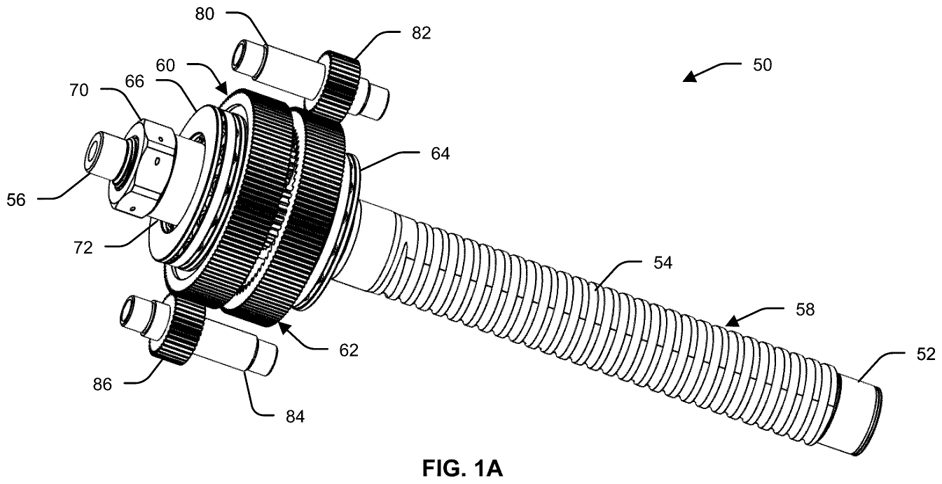

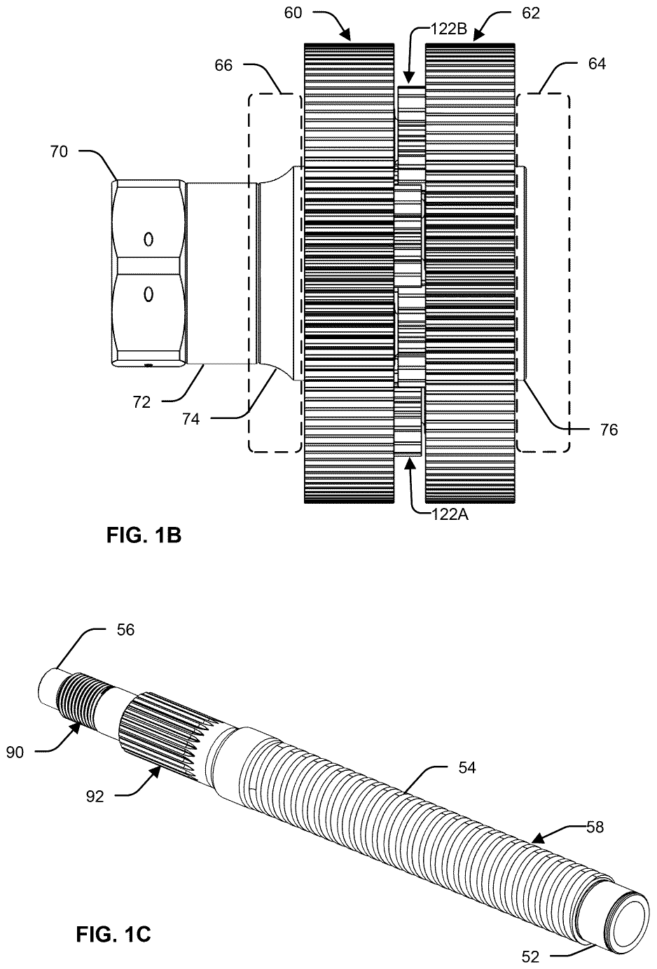

FIG. 1A illustrates a perspective view of an example speed summing, drive gear differential assembly 50 employing multiple planetary gears. As shown, drive gear differential assembly 50 includes first and second ring gears 60 and 62. As shown, first and second input gears 86 and 82 and corresponding shafts 84 and 80 can be selectively engaged to drive the first and second ring gears 60 and 62. A splined lead screw shaft 58, having a plurality of threads 54, can have a first end 56 extend through the differential gear assembly. Thus, the shaft 58 can receive torque from rotation of the cage in response to ring gears 60 and 62 being driven by the input gears 86 and 82. Second or opposite end 52 and the threads 54 are designed to interface with the ball nut and enable it to travel back and forth along the length of the shaft 58 as the differential turns in response to a torque from the input gears 86 and 82. When inserted, the splined lead screw shaft 58 is secured by nut 70 and its position maintained with a spacer 72. Thrust assembly bearings 64 and 66 are arranged on opposing ends of the drive gear assembly.

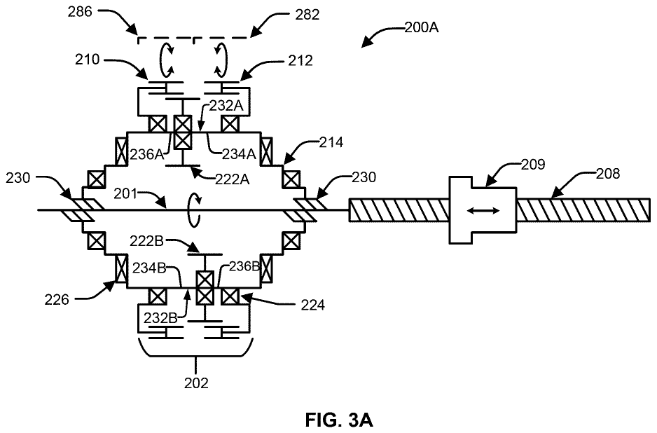

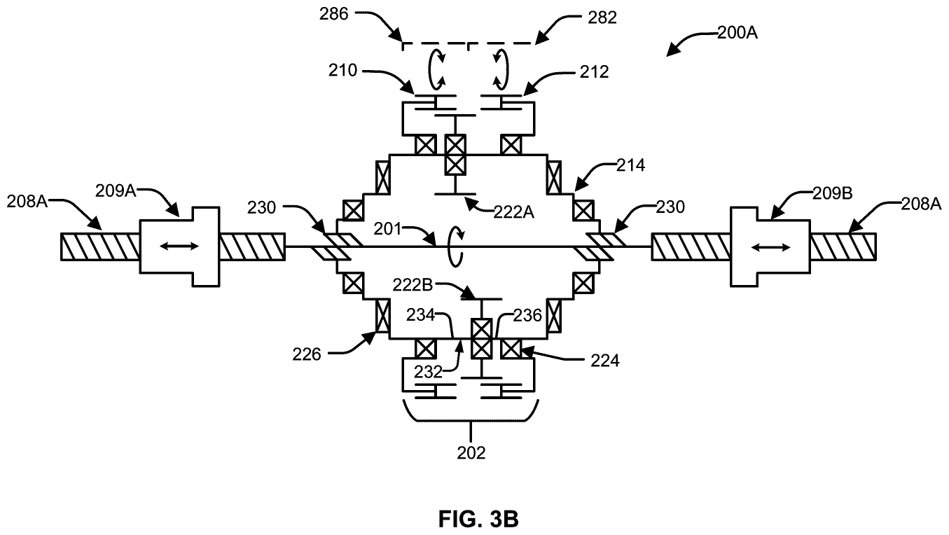

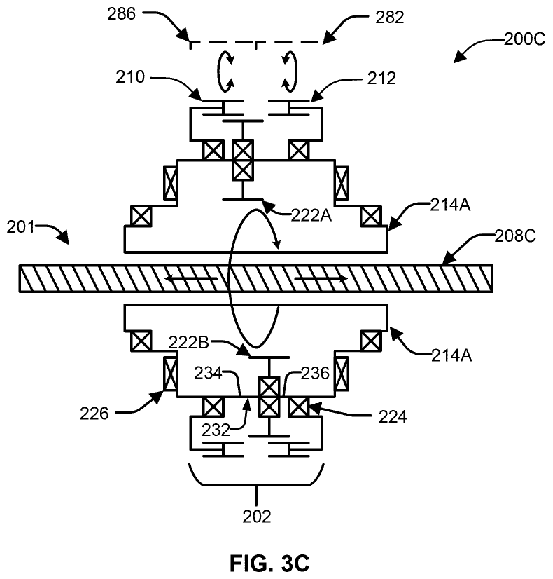

In operation, and as shown in FIG. 1A, the first end 56 of the shaft 58 is a splined end extending through the differential assembly. Thus, if the lead screw is being driven by the differential, the rotational movement of the lead screw translates into linear motion of adapter output (e.g., adapter output 209 of FIGS. 3A and 3B). In other examples, if the lead screw is being backdriven by the adapter output, the threads 54 serve to transfer axial movement of the adapter output into rotary motion of the differential assembly and the gears therein.

In some disclosed examples, the second end 52 of the shaft 58 can either be threaded (as shown with the extension having threads 54), or can be without threads. In such a case, a non-threaded shaft can rotate in accordance with this disclosure, and can interface with a moveable device via an alternative connection means, such as a fastener, bolt, weld, adhesive,.

As provided in FIGS. 1A and 1B, the example drive gear differential assembly 50 includes first and second planetary gear sets 122A and 122B to drive ring gears 60 and 62. The planetary gear sets are arranged in a carrier or cage having a compression component 74 and a tension component 76. Each planetary gear 122 is configured to rotate about a planetary gear support pins, supported by planetary gear radial support bearings. The relative positions of the compression component 74 and the tension component 76 are maintained by employing a fixed and rigid interface between the components and the lead screw shaft 58. The axial position of the planetary gear support pins is controlled by the thrust support bearings 64 and 66.

Spacers are arranged on opposite ends of each planetary gear (e.g., a short planetary gear spacer and a long planetary gear spacer) to align the gears with a corresponding ring gear, which can serve as an input and/or an output for the differential assembly 50. As disclosed herein, the assemblies function as planetary gears as the axes of each planet gear 122 revolves around a common central axis (e.g., coaxial with the splined lead screw shaft 58). Further, as shown in the several figures, when activated, each input ring gear (e.g., interfaces 60 and 62) meshes with the rotating planet gears (e.g., planet gear sets 122A and 122B) of the respective sets, such that an interior of each output ring gear meshes with the exterior of a corresponding planet gear. The arrangement and function of the planetary gear sets relative to the shown in FIGS. 3A to 3C.

The splined lead screw shaft 58 is shown in FIG. 1C. The splined lead screw shaft 58 includes an interface 92, such as a spline or other type of rigid interface for robust torque transfer, to provide a rigid interface with the cage. The spline 92 is configured to mate with the first and second planetary gears. The threaded portion 90 is arranged at the first end, to receive the nut 70 to secure the screw gear 58 to the drive assembly.

In some examples, the axial position of the splined lead screw shaft is fixed within the cage, such that rotation of the planetary rings causes rotation of the screw gear without axial movement of the splined lead screw shaft through the cage. One or more adapters can be arranged on the splined lead screw shaft, such that rotation of the splined lead screw shaft causes the adapter to move along a length of the splined lead screw shaft. The direction of travel of the adapter is controlled by the rotational direction of the external ring gear.

The disclosed assembly is configured to operate in one or more of three different outcomes, depending on which component or gear is grounded. For example, the first ring gear 60 can be driven by input gear 86, thereby driving the first set of planetary gears. With the second ring gear 62 grounded, the cage is rotated half the angular speed of the first ring gear. As the spline lead screw shaft is in a fixed relationship with the cage, the spline lead screw shaft is also rotated.

In another example operation, the second ring gear 62 is driven by input gear 82, and driving the second set of planet gears. In this example, the first ring gear 60 is grounded. As a result, the cage and spline lead screw shaft are rotated at half the angular speed of the second ring gear 62.

In yet another example operation, the spline lead screw shaft and cage receive toque from the first or second ring gear via a corresponding set of planetary gears. The other of the first or second ring gear is therefore driven at the same angular velocity as the input gear.

In some examples, shafts 84 and 80 are configured to be driven by a mechanical power source, such as a motor, solenoid, or actuator, via one or more gears, a clutch, a belting system, a roller chain and sprocket, or other suitable system.

Although the example of FIGS. 1A to 1C is illustrated as a two-branch design, more than two input rings are also possible by employing the concepts disclosed herein. Additionally or alternatively, each ring gear or interface can be employed as an output. For example, a power source can drive one or more of the ring gears via the screw gear, and/or by driving any other of the ring gears.

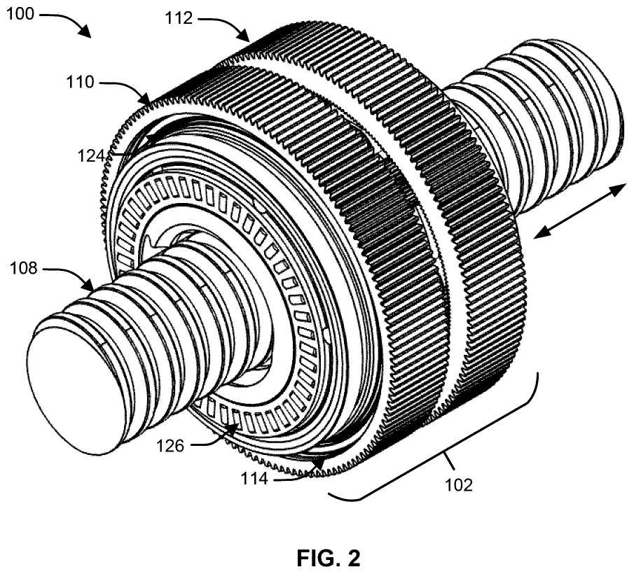

FIG. 2 illustrates another example speed summing differential 102 incorporated in a gear assembly 100, employing multiple sets of planetary gears (e.g., similar to planetary gears 122A and 122B) to drive and/or be driven by first and second external ring gears 110 and 112. Support pins are arranged about a carrier or cage 114, the pins fitting into holes of the cage 114 to support the planetary gears, which are arranged and/or operate in a manner similar to those described with respect to FIGS. 1A to 1C. For example, pins support the planetary gears close to the perimeter of the cage 114, such that they are aligned (e.g., via short and long spacers) to mate with ring gears 110 and 112. Ring gear radial support bearings 124 are aligned with the ring gears, and axial support bearings 126 are arranged along opposite sides of the cage 114.

The cage 114 is formed with a series of internal threads, to receive external threading of a translating lead screw shaft 108. In operation, as the cage 114 rotates, the lead screw shaft 108 traverses the cage due to the force between the internal threads and external threading. For instance, an external ring gear can receive torque from a motor or other actuator, the resulting rotation drives a set of planetary gears, which rotates the cage, thereby causing transverse movement of the screw gear. The inverse is also possible, as movement of the screw gear can cause rotation of the planetary gears, which then drive the external ring gears.

FIGS. 3A to 3C illustrate diagrammatic views of example differential assembly layouts and their operational outputs. FIG. 3A illustrates an example differential assembly 200A, configured to rotate an adapter output 209 in response to rotation of a lead screw shaft 208. As shown, the lead screw shaft 208 rotates about a central axis 201, driven by rotation of a cage 214. The rotational movement of the planetary gear sets 222A and 222B is driven by receiving driving torque from one of first or second external input/output sources 286 and 282. Gearing from external sources 286 and 282 mate with ring gears 210 and 212, respectively, which drive planetary gear sets 222A and 222B, respectively. As explained above with respect to FIGS. 1A through 1C, rotation of the planetary gear sets (e.g., sets of multiple planetary gears) serves to drive rotation of the lead screw shaft 208. When the axial position of the screw gear 208 is fixed relative to the cage 214, rotation of the planetary gear sets 222A and/or 222B, and therefore the lead screw shaft 208, causes rotation of the adapter output 209 along a length of the lead screw shaft 208.

As shown, spacers are used to align the first set of planetary gears 222A with the first ring gear 210, and the second set of planetary gears 222B with the second ring gear 212. More specifically, a short spacer 236A is arranged on support pins 234A of a side of the carrier/cage supporting the first ring gear 210, thereby locating the first set of planetary gears 222A to overlap with the first ring gear 210. The long planetary gear spacers 234A extend along the support pins 232A from a side of the first planetary gears opposite the short spacers 236A. The long spacers 234A reach the opposite side of the carrier/cage, holding the first planetary gears 222A in place, overlapping the first ring gear 210.

The second set of planetary gears 222B is similarly arranged, but with the short spacers 236B and long spacers 234B on opposite positions relative to the first set of planetary gears and corresponding spacers. Thus, the second set of planetary gears 222B are aligned with the second ring gear 212, and their position maintained by the short spacers 236B and long spacers 234B. In some examples, each set of planetary gears includes three planetary gears (for a total of six planetary gears), arranged about a centerline 201 in an alternating pattern. Some example assemblies employ four planetary gears in each set (for a total of eight planetary gears).

In some examples, the assembly 200A can include first and second ring gear radial support bearings 224 to facilitate free rotation of the ring gears relative to the carriage/cage, the ring gear radial support bearings being maintained by one or more retaining rings. One or more axial bearing 226 can also be employed. The assembly may be grounded via a mechanical ground 230, connected to the cage 214.

FIG. 3B illustrates an example differential assembly 200A, configured to rotate an adapter output 209A and 209B in response to rotation of a lead screw shaft 208A. As shown, the lead screw shaft 208 rotates about a central axis 201, driven by rotation of a planetary gear sets 222A and 222B. The rotational movement of the planetary gear sets 222A and 222B is driven by receiving driving torque from one of first or second external input/output sources 286 and 282. Gearing from external sources 286 and 282 mate with ring gears 210 and 212, respectively, which drive planetary gear sets 222A and 222B, respectively. As explained above with respect to FIGS. 1A through 2, rotation of the planetary gears (e.g., sets of multiple planetary gears) serves to drive rotation of the lead screw shaft 208A. When the axial position of the lead screw shaft 208A is fixed relative to the cage 214, rotation of the planetary gear sets 222A and 222B, and therefore the lead screw shaft 208A, causes rotation of the adapter output 209A or 209B along a length of the lead screw shaft 208A.

As shown, spacers are used to align the first set of planetary gears 222A with the first ring gear 210, and the second set of planetary gears 222B with the second ring gear 212. More specifically, a short spacer 236A is arranged on support pins 234A of a side of the carrier/cage supporting the first ring gear 210, thereby locating the first set of planetary gears 222A to overlap with the first ring gear 210. The long planetary gear spacers 234A extend along the support pins 232A from a side of the first set of planetary gears opposite the short spacers 236A. The long spacers 234A reach the opposite side of the carrier/cage, holding the first set of planetary gears 222A in place, overlapping the first ring gear 210.

The second set of planetary gears 222B is similarly arranged, but with the short spacers 236B and long spacers 234B on opposite positions relative to the first set of planetary gears and corresponding spacers. Thus, the second set of planetary gears 222B are aligned with the second ring gear 212, and their position maintained by the short spacers 236B and long spacers 234B extending along the support pins 232B from a side of the second set of planetary gears opposite the short spacers 236B. In some examples, each set of planetary gears includes three planetary gears (for a total of six planetary gears), arranged about a centerline 201 in an alternating pattern. Some example assemblies employ two, three, four or more planetary gears in each set (for a total of eight planetary gears-or twofold of the number of planetary gears used in each set). The number of planetary gears in each set can be determined based on the size of the individual gears, cage, and/or the assembly, which may limit the number of gears that can fit within. The number of gears can also impact load distribution and/or capacity of the assembly.

In some examples, the assembly 200A can include first and second ring gear radial support bearings 224 to facilitate free rotation of the ring gears relative to the carriage/cage, the ring gear radial support bearings being maintained by one or more retaining rings. One or more axial bearing 226 can also be employed.

In some disclosed examples, such as those described with respect to FIGS. 1A to 1C, the differential gear assembly employs a carrier or cage with two components: a first for tension, and a second for compression. The tension and compression components of this example assembly enable alignment of the various interfaces and mating of opposing gears, thereby ensuring desirable operation. For example, both tension and compression components of the cage interface with the splined lead screw shaft through an internal spline. The cage components have precision formed holes for receiving planet gear support pins, to which the pins should be pressed. The precision holes are arranged in pairs depending on how many planet gear pairs may be used. The pin holes and the internal spline are clocked to one another to ensure both cage components can be assembled onto the splined lead screw shaft with the internal/external splines as well as the pins and pin holes on both cages lining up. In order for the differential assembly to support axial loads (which may go through the planet gear support pins), the support pin lengths are controlled to equally distribute load forces among each of the pins. Both cages also support axial thrust bearings and washers and/or raceways.

The ring gears with external gearing are formed with internal gear teeth to interface with external gear teeth of the set of corresponding planetary gears. The external gear teeth of the ring gears are configured to interface with an EMA geartrain. Each ring gear has an inner diameter designed to interface with a ring gear radial support bearing and a bearing retaining ring. The size of the gear teeth formed on this ring gear are selected to meet desired dimensions (e.g., according to American Gear Manufacturers Association (AGMA) suggested rim thickness) to ensure structural integrity.

Each planetary gear within a set of planetary gears is configured to interface with a corresponding ring gear. Small flanged bearings provide radial support for the planetary gears and interface with the planet support pins. The size of the planetary gear is selected to provide clearance between the outer dimension of the planetary gear and the outer dimension of the splined lead screw shaft external spline, or the outer dimension of the lead screw nut shown in FIG. 2. The planet gears are arranged in pairs and are staggered within each pair. This allows for alternating planet gears to be arranged about the center of the cage. As disclosed herein, the small flanged bearings may be referred to as miniature or instrument flanged radial bearings. Such bearings could be substituted with miniature or needle roller bearings, as in the concept illustrated in FIG. 2.

To ensure proper spacing and alignment between each planetary gears and corresponding mesh, and between each set of planetary gears and their corresponding external ring gear, long and short planetary gear spacers are employed. Both types of spacers are used to control the location of the planet gears along the planet support pins. These locations are controlled such that each planet gear will only mesh with a single ring gear. This is achieved through staggering of the planet gears within each pair, which is controlled by using spacers. Both spacers' internal dimension is sized to allow smooth translation along the planet support pins, while the spacer length is controlled for precise positioning of the planet gears along the support pin.

The use of planetary gear support pins enables precise location and secure arrangement of the planet gears along the pins, relative to the other planetary gears, ensuring smooth operation of the differential assembly. Each pin has a precision formed outer diameter that serves as a pilot for the flanged ball bearings that radially support the planetary gears. Pins should have precision controlled length as well, which is needed to be able to equally distributed axial load going through the differential cage and pin assembly.

Each ring gear is arranged along an outer diameter of a ring gear radial support bearing. These bearings provide radial support for the ring gear as it rotates about the cage. The bearings are retained within the ring gear by use of a retaining ring. This bearing is sized to carry sufficient radial loads that support the separation loads on the drive gear. It should also have very low radial backlash. A relatively thin section type has improved utility due to the overall size of the differential.

Each planetary gear is mounted to its support pin via a radial support bearing. This support bearing enables smooth rotation of the planetary gears. The support bearings are sized to support separation loads acting upon the multiple planetary gears. Depending on a desired load capacity, the radial support bearing may be replaced with needle roller bearings and/or bushing sleeves to provide greater load capacity.

One or more retaining rings are employed to control an axial position of each ring gear. For example, each ring gear has some axial clearance between the internal teeth and the planet gear teeth meshing with the other ring gear. In some examples, the retaining ring sits in a groove machined into the ring gear. Different types of retaining rings, such as open or spiral types, are considered and may be employed depending on the level of axial load capacity desired.

In view of the unique arrangement of components, the drive gear differential assembly is configured as a speed summing architecture. It allows the EMA to drive the differential with two separate motors directly or through speed reduction gearing. The configuration of the differential assembly allows the EMA motors to be placed at various locations, enabling the EMA to have a flatter envelope profile. Both motors can be operated either in an active-active or active-standby mode.

When operating the EMAs in an active-active mode, both motors drive the lead screw shaft, and the differential “speed-sums” both inputs. The planet gears may or may not spin relative to the ring gears, and both ring gears do not spin relative to one another depending on the relative speed of both motors. For instance, if both motors drive the ring gears (inputs) at the same speed, the planet gears will not spin relative to the ring gears. If one motor drives a corresponding ring gear at a first speed, and the other motor drives a corresponding ring gear at a second speed, if the first speed is different than second speed then the planet gears will spin relative to each other and the ring gears by the difference in speed of the ring gears.

For example, when operating the EMA in an active-standby mode, a single motor drives the lead screw shaft, while the output shaft of the other motor is locked. Planet gears spin relative to one another and to both ring gears. With one of the ring gears locked, the other ring gear spins according to the angular speed of the driving motor. The relative movement of the planet gears and the ring gears causes the differential to induce additional 2:1 speed reduction because only one input to the differential is driven by the respective drive motor, while the other one is locked.

Other speed summing differentials used in EMA applications utilize one or more central sun gears to drive the planetary gears, which would then drive the cage and an integrated pinion gear. The sun gear is connected to an input gear through an integral shaft, while a second sun gear would be connected to its own input gear also through an integral shaft that would be concentric to the first one.

By contrast, the disclosed drive gear integrated differential gearing assembly employs input gears to directly drive the planet gears through internal gear teeth machined into the ring gears. The planet gears then transfer mechanical power from the input ring gears to the leadscrew gear through planet support pins, and the cage through a splined interface into the lead screw. Axial load is also transferred from the leadscrew into the housing through the differential assembly, more specifically through the planet support pins.

FIG. 3C illustrates another example differential assembly 200C, configured to translate lead screw shaft 208C relative to the rotating cage 214A, in a manner similar to the differential gear assembly illustrated in FIG. 2. For example, the speed summing differential 202 employs multiple sets of planetary gears 222A and 222B to drive and/or be driven by first and second external ring gears 210 and 212. The cage 214A is formed with a series of internal threads to receive external threading of translating lead screw shaft 208A. In operation, as the cage 214A rotates in response to rotation of the planet gears, the lead screw shaft 208A traverses the cage 214A due to the force between the internal threads and external threading. For instance, the spline of the lead screw shaft is designed to ensure proper clocking of the tension component to the compression component such that alignment of the planet support pins is maintained. Further, the internal threads of the cage are used for torque transmission between the differential and the lead screw shaft.

In some examples, the external ring gears can receive torque from a motor or other actuator 286 or 282, the resulting rotation drives a set of planetary gears, which rotates the cage, thereby causing axial movement of the screw gear through the cage. The inverse is also possible, as movement of the screw gear can cause rotation of the planetary gears, which then drive the external ring gears.

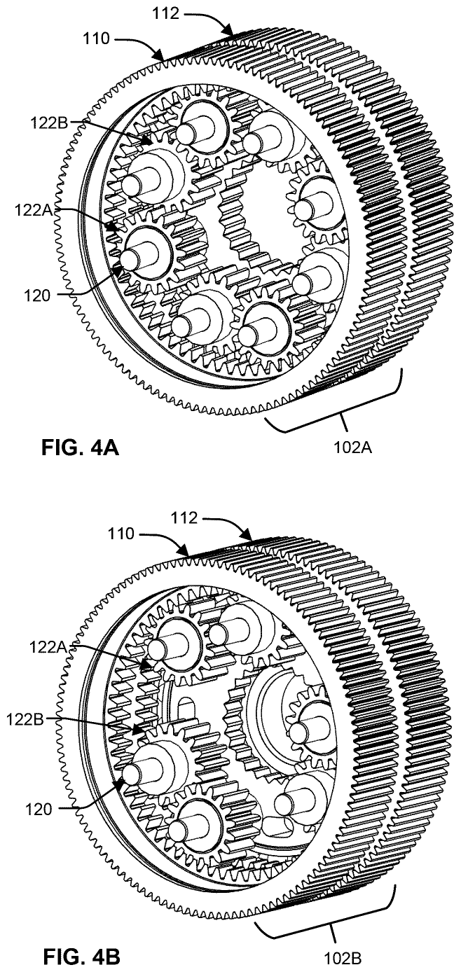

FIG. 4A provides a perspective view of an epicyclic drive gear with an integrated differential 102A including external ring gears 110 and 112. The differential 102A employs a first set of three planetary gears 122A to drive or be driven by gear 110, and a second set of three planetary gears 122B to drive or be driven by gear 112. Each planetary gear rotates about a pin 120, held in alignment with their corresponding ring gear by use of short and long planetary gear spacers, as explained herein.

FIG. 4B provides a perspective view of another, high-capacity epicyclic drive gear with an integrated differential 102B including external ring gears 110 and 112. Here, the differential 102B employs a first set of four planetary gears 122A to drive or be driven by gear 110, and a second set of four planetary gears 122B to drive or be driven by gear 112.

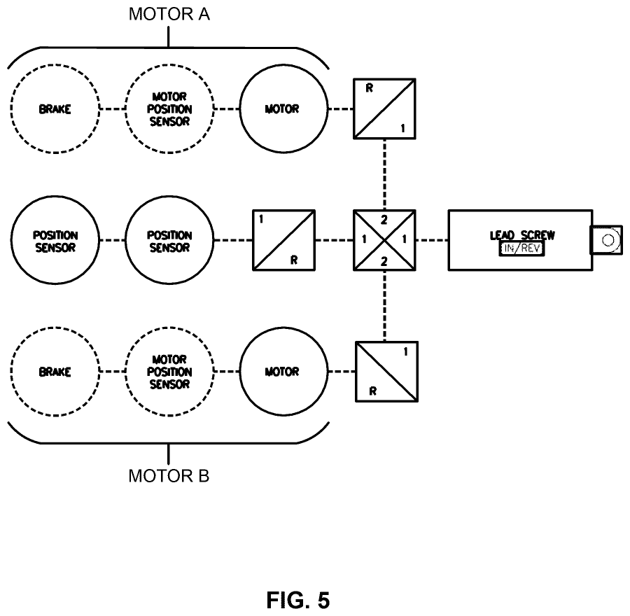

FIG. 5 is a diagrammatic view of a differential gear assembly arranged to receive power from multiple mechanical power sources (e.g., EMAs or motors) via a power transmission system. Each power source can be connected to an external ring gear, as well as a motor position sensor and a brake (e.g., an electromechanical braking system). In an example, the motors may include an electrical, hydraulic, or pneumatic motor. In the case of electric motors, it may include a brushless DC motor, brushed DC motor, AC induction motor, or stepper motor, although other motors may be utilized based on available space and power requirements, for example. In some examples, other transmissions may be employed, such as a clutch, belting system, or other systems or methods of transferring power from a power source.

The motors can be selectively activated, depending on a desired output at the splined lead screw shaft. For example, a first motor can cause the lead screw to rotate at a first speed, while a second motor can cause the lead screw to rotate at a second speed. If activated simultaneously, the splined lead screw shaft will rotate at a speed which is the sum of the first and second speeds. In some examples, the first and second speeds are the same, whereas in some examples the first and second speeds are different.

An advantage of the disclosed differential gear assemblies is the compact size achieved through the specific arrangement of the multiple planetary gears, screw gear, and the use of ring gears that feature both internal and external gears. This particular design approach also reduces the number of support bearings required versus a more traditional way of achieving multiple branch outputs, as described above. The compact size of this design leads to other advantages when the device is integrated within a larger torque distribution assembly, where its compact envelope and versatility of placement provide a significant advantage for use in constricted spaces.

As disclosed herein, when both inputs are being driven, the output equals the sum of the speed of both inputs. More precisely, the angular speed of the differential output is the sum of the angular speeds of both input ring gears. When only one input is driven, while the other is locked, however, the differential will act as speed reducing gearing. In this example, the angular speed of the differential output is reduced by a factor of two, compared with the angular speed of the driving input ring gear.

In the example illustrated in FIG. 5, a first motor (MOTOR A) is configured as a motor-sensor-brake. A second motor (MOTOR B). The motors are capable of operating in a number of modes, including an active-active mode and an active-standby mode.

In active-active mode, both MOTOR A and MOTOR B drive the lead screw (e.g., a splined lead screw) with a resulting output speed being the combined speeds of the MOTOR A and the MOTOR B. Total torque output at the lead screw is therefore the sum of what MOTOR A and MOTOR B provide.

In active-standby mode, only one of MOTOR A or MOTOR B drives the lead screw, while the other is locked (e.g., by the included brake). In this scenario, the speed output through the differential is reduced, while the torque output is multiplied by a factor of 2:1 compared to the torque delivered in the active-active mode.

The disclosed drive gear assembly solves these problems by integrating a speed summing differential gearing into a drive gear that is normally attached to a leadscrew. This arrangement, which incorporates differential gearing into the drive gear, results in a very compact package and does not take any more space than a typical drive gear would.

In disclosed examples, a differential gear assembly configured for speed summing of multiple gears includes a first ring gear; a second ring gear; a splined lead screw shaft; a first set of planetary gears configured to be driven by the first ring gear; a second set of planetary gears configured to be driven by the second ring gear; and a cage to house the first and second sets of planetary gears, wherein the cage is configured to rotate in response to the first or second ring gear driving the first and second set of planetary gears.

In some examples, the differential gear assembly further includes one or more planetary gear support pins to support each planetary gear of the first and second sets of planetary gears.

In examples, the differential gear assembly further includes one or more short planetary gear spacers and one or more long planetary gear spacers, wherein each of the one or more planetary gear support pins supports a short planetary gear spacer, a planetary gear, and a long planetary gear spacer opposite the short planetary gear spacer.

In some examples, the cage comprises a plurality of holes formed to receive the planetary gear support pins, the differential gear assembly further comprising a radial support bearing to maintain a position of the first set of planetary gears and the second set of planetary gears within the cage.

In some examples, the first set of planetary gears and the second set of planetary gears are arranged radially about the cage in an alternating pattern.

In some examples, each of the first set of planetary gears and the second set of planetary gears include three gears.

In some examples, each of the first set of planetary gears and the second set of planetary gears include four or more gears.

In some examples, the splined lead screw shaft includes external threading, the cage includes internal threads to mate with the external threading of the splined lead screw shaft.

In some examples, rotation of the cage causes translation of the splined lead screw shaft through the cage.

In some examples, the differential gear assembly further includes a first input gear configured to be driven by a first motor at a first speed, and a second input gear configured to be driven by a second motor at a second speed.

In some examples, the first input gear is configured to be driven independently of the second input gear.

In examples, the first input gear is configured to be driven simultaneously with the second input gear.

In examples, simultaneously driving the first input gear and the second input gear causes the splined lead screw shaft to rotate at a speed which is a sum of the first and second speeds.

In some disclosed examples, a differential gear assembly configured for speed summing of multiple gears includes a first interface; a second interface; a splined lead screw shaft; a first set of planetary gears configured to be driven by the first interface; a second set of planetary gears configured to be driven by the second interface; and a cage to house the first and second sets of planetary gears, wherein the splined lead screw shaft extends through a portion of the cage and is configured to rotate in conjunction with the cage in response to the first or second ring gear driving the first or second sets of planetary gears.

In some examples, the cage comprises a tension component and a compression component arranged on opposite sides of the first and second sets of planetary gears.

In some examples, the differential gear assembly further includes one or more planetary gear support pins to support each planetary gear of the first and second set of planetary gears.

In examples, the one or more planetary gear support pins extend through the tension component and the compression component to secure the cage about the first and second sets of planetary gears.

In examples, the splined lead screw shaft extends through the tension component and is secured to the compression component by a nut fastened to a first end of the splined lead screw shaft.

In some examples, an axial position or orientation of the splined lead screw shaft is fixed relative to the cage.

In some examples, the first or second interfaces are connected to one or more mechanical power sources to drive the first or second interfaces.

In examples, the one or more mechanical power sources include a motor, solenoid or actuator.

In examples, the first and second interfaces are one or more of a gear, a belt, or a roller chain and sprocket.

In some disclosed examples, a differential gear assembly configured for speed summing of multiple gears includes a first ring gear; a second ring gear; a splined lead screw shaft; a first set of planetary gears configured to be driven by the first ring gear; a second set of planetary gears configured to be driven by the second ring gear; and a cage having a tension component and a compression component, the cage to house the first and second sets of planetary gears, wherein the cage including internal threads to mate with external threads of the splined lead screw shaft.

In some examples, the splined lead screw shaft is configured to rotate in response to the first or second ring gear driving the first and second sets of planetary gears.

In some examples, the external threads of the splined lead screw shaft are designed to maintain desired clocking of the tension component to the compression component such that alignment of one or more planet support pins is maintained.

In some examples, the internal threads of the cage are configured to transmit torque between the first and second ring gears and the splined lead screw shaft.

Certain aspects of the disclosure may be found in a method and system for a differential gear assembly. With reference to the several figures, multiple advantages are achieved through the innovative differential gear assembly disclosed herein.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A differential gear assembly configured for speed summing of multiple gears comprising:
a first ring gear;
a second ring gear;
a splined lead screw shaft;
a first set of planetary gears configured to be driven by the first ring gear;
a second set of planetary gears configured to be driven by the second ring gear; and
a cage to house the first and second sets of planetary gears,
one or more planetary gear support pins to support each planetary gear of the first and second sets of planetary gears and one or more short planetary gear spacers and one or more long planetary gear spacers, wherein each of the one or more planetary gear support pins supports a short planetary gear spacer, a planetary gear, and a long planetary gear spacer opposite the short planetary gear spacer, and
wherein the cage is configured to rotate in response to the first or second ring gear driving the first and second set of planetary gears.

2. (canceled)

3. (canceled)

4. The differential gear assembly of claim 12, wherein the cage comprises a plurality of holes formed to receive the planetary gear support pins.

5. The differential gear assembly of claim 1, wherein the first set of planetary gears and the second set of planetary gears are arranged radially about the cage in an alternating pattern.

6. The differential gear assembly of claim 1, wherein the splined lead screw shaft includes external threading, the cage includes internal threads to mate with the external threading of the splined lead screw shaft.

7. The differential gear assembly of claim 1, wherein rotation of the cage causes translation of the splined lead screw shaft through the cage.

8. The differential gear assembly of claim 1, further comprising a first input gear configured to be driven by a first motor at a first speed, and a second input gear configured to be driven by a second motor at a second speed.

9. The differential gear assembly of claim 8, wherein the first input gear is configured to be driven independently of the second input gear.

10. The differential gear assembly of claim 8, wherein the first input gear is configured to be driven simultaneously with the second input gear.

11. The differential gear assembly of claim 10, wherein simultaneously driving the first input gear and the second input gear causes the splined lead screw shaft to rotate at a speed which is a sum of the first and second speeds.

12. A differential gear assembly configured for speed summing of multiple gears comprising:
a first interface;
a second interface;
a splined lead screw shaft;
a first set of planetary gears configured to be driven by the first interface;
a second set of planetary gears configured to be driven by the second interface; and
a cage to house the first and second sets of planetary gears,
wherein the splined lead screw shaft extends through a portion of the cage and is configured to rotate in conjunction with the cage in response to the first or second ring gear driving the first or second sets of planetary gears.

13. The differential gear assembly of claim 12, wherein the cage comprises a tension component and a compression component arranged on opposite sides of the first and second sets of planetary gears.

14. The differential gear assembly of claim 13, further comprising one or more planetary gear support pins to support each planetary gear of the first and second set of planetary gears.

15. The differential gear assembly of claim 14, wherein the one or more planetary gear support pins extend through the tension component and the compression component to secure the cage about the first and second sets of planetary gears.

16. The differential gear assembly of claim 13, wherein the splined lead screw shaft extends through the tension component and is secured to the compression component by a nut fastened to a first end of the splined lead screw shaft.

17. The differential gear assembly of claim 12, wherein an axial position or orientation of the splined lead screw shaft is fixed relative to the cage.

18. The differential gear assembly of claim 12, wherein the first or second interfaces are connected to one or more mechanical power sources to drive the first or second interfaces.

19. A differential gear assembly configured for speed summing of multiple gears comprising:
a first ring gear;
a second ring gear;
a splined lead screw shaft;
a first set of planetary gears configured to be driven by the first ring gear;
a second set of planetary gears configured to be driven by the second ring gear; and
a cage that houses the first and second sets of planetary gears,
wherein the cage including internal threads to mate with external threads of the splined lead screw shaft, such that rotation of the cage causes the splined lead screw shaft to traverse the cage.

20. The differential gear assembly of claim 19, wherein the splined lead screw shaft is configured to rotate in response to the first or second ring gear driving the first and second sets of planetary gears.

21. (canceled)

22. The differential gear assembly of claim 19, wherein the internal threads of the cage are configured to transmit torque between the first and second ring gears and the splined lead screw shaft.

23. The differential gear assembly of claim 1, wherein the cage is fixed with respect to the splined lead screw shaft, and splines of the splined lead screw shaft are configured to mate with at least one of the first and second sets of planetary gears.

24. The differential gear assembly of claim 19, further comprising a short planetary gear spacer and a long planetary gear spacer, wherein the short planetary gear spacer and long planetary gear spacer are positioned on opposite sides of a planetary gear.
